(19) United States
(12) Patent Application Publication
(10) Pub. No.: US 2014/0021124 A1
(43) Pub. Date: Jan. 23, 2014

(54) Form-Molded Filter Element and Method

(71) Applicants: Gerard Malgorn, Quimper (FR); Arnaud Le Ven, Ergue Gaberic (FR)

(72) Inventors: Gerard Malgorn, Quimper (FR); Arnaud Le Ven, Ergue Gaberic (FR)

(73) Assignee: CUMMINS FILTRATION IP, INC., Columbus, IN (US)

(21) Appl. No.: 13/616,273

(22) Filed: Sep. 14, 2012

(30) Foreign Application Priority Data
Jul. 19, 2012 (FR) 12/56978

(51) Int. Cl. B01D 29/13; B01D 29/11

(52) U.S. Cl. CPC B01D 29/13; B01D 29/111
USPC 210/323.1; 210/451; 210/450; 264/503

(57) ABSTRACT

A form-molded filter element cartridge has a pass-through filter-media sidewall through which fluid passes and is filtered, and has at least one filter-media flange compressively engageable to form a seal between a first dirty unfiltered-fluid side of the filter-media sidewall and a second clean filtered-fluid side of the filter-media sidewall. A method is provided for making the filter element cartridge.

### CROSS-REFERENCE TO RELATED APPLICATIONS

This application claims the benefit of and priority from, and includes the disclosure of, French patent application Ser. No. 12/56978, filed Jul. 19, 2012, incorporated herein by reference.

### PARENT FRENCH APPLICATION

The following is an English translation in accordance with the above noted parent French application and the present disclosure.

### BACKGROUND AND SUMMARY

The disclosure relates to the field of designing and making of filters and filter assemblies used to filter fluids, including fluids flowing in hydraulic motors or apparatuses, and other fluid flow applications.

A filter assembly consists of a filter element, comprising a vessel and a cover, within which there is disposed a filter cartridge including a filtering medium, generally cylindrical in shape and surrounding a tubular cavity, the filtering medium being made for example of paper, cardboard or again out of felt or another porous material, such as a synthetic non-woven material.

The filter cartridge also generally comprises two end flanges demarcating the filtering medium and enabling the filter cartridge to be fixedly joined to the filter element.

The filter cartridge cooperates most usually with a tube, in particular a center tube, which may or may not be fixedly joined to the flanges. The external diameter of the tube is close to the internal diameter of the tubular cavity surrounded by the filtering medium, so as to limit the deformations of the medium caused by the pressure exerted within the filter assembly.

The end flanges are formed by a first flange, which may consist of an upper flange, and by a second flange, which may consist of a lower flange, both made out of a metallic or polymer material. The role of the flanges is to participate in the tight sealing of the filter cartridge and to enable the fixed joining of the filter cartridge to the permanent part of the filter assembly.

The filter cartridge is, in this type of filter assembly, generally removable or detachable so it can be replaced at the end of its service life by a new filter cartridge.

The operator dismounts the cover of the filter assembly, then grasps the filter cartridge, withdraws it from the vessel and replaces it by a new filter cartridge.

The filter cartridge, formed by materials different from those constituting at least the filtering medium and the flanges, is discarded, constituting a waste. Thus the quantity of wastes is great.

The filtering medium is generally formed by cutting out fibrous material and pleating it. The number of pleats can vary from one filter cartridge to another. This does not give equal quality from one filter cartridge to another. Moreover, the filters, through constant use of the filter assembly and under the pressure of the fluid to be filtered, can get agglomerated into packets so that the filter assembly no longer plays its filter role properly. Furthermore, the method for manufacturing the filtering medium is relatively difficult to implement, requiring especially a large number of steps and handling operations, mobilizing considerable labor force.

The filter cartridges may not be stackable on one another nor get pleated on themselves, thus requiring substantial volume for storage and transport.

In one embodiment the disclosure provides a filter assembly that minimizes the quantity of wastes during the replacement of the filter cartridge and is thus more ecological.

In another embodiment a filter assembly has a filter cartridge with a limited number of pleats, if necessary.

In another embodiment the disclosure provides a filter assembly with a filter cartridge for which the positioning of the pleats remains substantially unchanged during the service life of the filter cartridge.

In another embodiment the disclosure provides a filter assembly for which the method of manufacture is facilitated.

In another embodiment the disclosure provides a filter assembly comprising a filter cartridge that can be stacked on one or more filter cartridges before it is placed in the filter assembly, and/or can be stored in being pleated on itself, outside the filter assembly.

In one embodiment the filter assembly comprises:
a filter element including a vessel and a cover,
a removable filter cartridge disposed inside the filter element, and constituted essentially, in particular exclusively, by a filtering medium,
an internal structure within the filter element, fixedly joined to at least a part of the filter element, configured to support the filter cartridge in the filter element.

In one embodiment the filter cartridge comprises a filtering medium that enables the quantity of wastes to be reduced when replacing the filter cartridge, comprising at least one first flange and one second flange for example.

In an additional embodiment the filter cartridge is supported and held within the filter element, in order to properly fulfill its role of filter of the fluid that flows inside the filter assembly.

The filter assembly is designed to enable the entry of fluid to be filtered and also the removal of the filtered fluid and the sending of this fluid into the hydraulic motor or apparatus. Thus, the filter assembly comprises an aperture for the inlet of the fluid to be filtered and an aperture for the outlet of the clean, filtered fluid.

The internal structure inside the filter element, which supports the filter cartridge in the filter element, is configured to also enable the filtering and flow of dirty and then clean fluid in the filter assembly

In one embodiment the filter cartridge is made out of a filtering medium, and there is provided an internal structure, which constitutes an internal skeleton of the filter assembly, extending into the filter element.

According to one embodiment, the filter cartridge comprises at least one filtering edge, made at least partially, and in one embodiment totally, out of a filtering medium, and configured to form, with a part of the internal structure with which the filtering edge is in contact, a supporting area for the filter cartridge.

The supporting area is laid out in one embodiment to prevent the passage of fluid except through the filtering edge.

In one embodiment, while not providing perfect sealing, the supporting area, even though it does not completely prevent the passage of fluid, filters it through the filtering edge, in such a way that the fluid which passes through the filtering edge is filtered, thus not hampering the working of the filter assembly.

In one embodiment, the internal structure comprises a first structural element and a second structural element, the first and second structural elements cooperating with each other, in one embodiment by pressing on said at least one filtering edge, to support the filter cartridge.

The first structural element may include a plurality of apertures enabling the passage of dirty fluid to be to be filtered, and the second structural element can comprise a plurality of apertures enabling the passage of clean, filtered fluid.

The filter cartridge can have a general cylindrical or truncated-cone shape and a cross-section with a shape chosen from among the following: a multipointed star shape, circular shape; substantially oval shape and almond shape, or other suitable cross-section shape.

The filter cartridge can have a first face in contact with the fluid to be filtered and a second opposite face in contact with the filtered fluid. For example, when the filter cartridge has a general cylindrical shape, the external face of the cylinder can correspond to the first face and the internal face of the cylinder can correspond to the second face.

The filter cartridge can have an upper filtering edge, extending to an upper end of the filter cartridge, or to its vicinity, and/or a lower filtering edge, extending to a lower end of the filter cartridge, or to its vicinity. Each of the upper and/or lower filtering edges can be held closely, especially by pressing, between the first and second structural elements, in one or two supporting areas.

The first structural element can at least partially have a general cylindrical or truncated-cone shape surrounding the filter cartridge or, respectively, surrounded by the filter cartridge, possibly outside the supporting area or areas. The second structural element can at least partially have a generally cylindrical or truncated-cone shape, surrounded by the filter cartridge or, respectively, surrounding the filter cartridge, possibly outside the support area or areas.

The filtering medium forming the filter cartridge can comprise a material chosen from the group constituted by cellulose, especially paper or cardboard, felt, a porous material, woven or non-woven, synthetic or non-synthetic material, a joining of these materials, or any other appropriate filtering medium.

The filtering medium can also include a plurality of superimposed layers of materials, for example in one embodiment at least three layers, preferably at least ten layers, or for example at least 25 layers, or even in particular 50 layers that are superimposed.

The presence of a superimposition of layers of materials forming the filtering medium may further improve the quality of filtering of the fluid.

In one embodiment, the first structural element is fixed in a tightly sealed way to the vessel of the filter element and the second structural element is fixed in a tightly sealed way to the cover of the filter element. In this case, during the replacing of the filter cartridge, the operator, who removes the cover of the filter element, simultaneously detaches the second structural element and therefore releases the filter cartridge. The fact that the first structural element is fixed to the vessel of the filter element makes it possible to hold the first structural element in place and in the right position and averts the need for the operator to manipulate it. The operation for replacing the filter cartridge is thus made easier.

In one embodiment, the filter cartridge comprises at least one cavity open at a first end and closed at a second opposite end. In this case, the dirty, unfiltered fluid can penetrate the cavity, is filtered and flows outside the cavity.

When the filter cartridge has a general cylindrical or truncated-cone shape with a first open end and a second open end, the unfiltered dirty fluid can come from outside the cylinder or the truncated cone forming the filter cartridge, and get filtered and then flow into the filter cartridge, through the second, open lower end.

The second structural element can take a shape arranged so as to appreciably match the shape of the filter cartridge, on a face, especially an internal face, of this cartridge. Such a shape can make it possible to prevent the collapse of the filter cartridge under the pressure of the fluid passing through the filtering medium. This can ensure the efficient functioning of the filter cartridge, throughout its duration of use.

In one embodiment, the filter cartridge comprises a plurality of cavities which may or may not be connected to one another. For example, the cavities can be connected by means of a common filtering edge. If the cavities are not connected to one another, each one of them can have a separate filtering edge of its own.

If the filter cartridge includes a plurality of cavities, then the internal structure can comprise, for all the cavities or for each cavity, a first structural element and a second structural element.

When the filter cartridge has a truncated-cone shape or a conical shape, it is possible to store several similar filter cartridges by stacking them on top of one another. In certain cases, it is possible to fold each one on itself, especially when there are no pleats.

The presence of a mandrel with a star-shaped section can enable the making of filtering layers that are strictly identical with one another, with a same number of pleats, thus improving the quality, by standardization, of the filter cartridges.

In another embodiment independently or in combination with the above, a method is provided for making a filter cartridge for a filter assembly to filter at least one fluid, the method for manufacturing comprising the following steps:
throwing fibers on to a mandrel so as to form a filtering medium, and
demolding the filter cartridge thus formed as a filtering medium from the mandrel.

The mandrel can have a general cylindrical or truncated-cone or conical shape.

The mandrel can have a star-shaped cross-section so as to reproduce the pleated aspect of the prior-art filter cartridges.

The mandrel can be symmetrical relative to a transverse plane and enable the simultaneous manufacture of two filter cartridges, for example identical to each other.

The mandrel can be driven in rotation relative to a fiber-throwing device so that its entire surface can be covered by fibers.

The method can also include the step for threading a ring of predetermined width on to the mandrel, so as to achieve a controlled reduction of the length of the filter cartridge to be manufactured, by electrospinning for example.

The method for manufacturing the filter cartridge can comprise the step consisting in superimposedly throwing fibers on the mandrel in a plurality of layers, for example three layers, five layers, ten layers or even 25 or 50 layers of fibers or even more, the maximum number of layers depending on the thickness of the finished filtering medium and the filtration level chosen. The medium can be obtained by electrospinning of polymer fibers.

### BRIEF DESCRIPTION OF THE DRAWINGS

Other features and aspects of the disclosure shall appear more clearly from the following description of embodiments, given by way of illustratory and non-exhaustive examples and from the appended drawings, of which:

FIG. 1 is a schematic cross-section view of a filter assembly according to a first embodiment of the disclosure.

FIG. 2 is a view similar to that of FIG. 1, illustrating the working of the filter assembly of FIG. 1.

FIG. 3 is a schematic, exploded view in longitudinal section of the filter assembly of FIG. 1.

FIG. 4 is a schematic, perspective and isolated view of the filter cartridge of the filter assembly of FIG. 1.

FIG. 5 is a perspective, schematic and isolated view of a variant of a second structural element of the internal structure which can be used in the filter assembly of FIG. 1.

FIG. 6 is a schematic representation in perspective of the method for manufacturing one or, especially, two filter cartridges, according to another aspect of the disclosure.

FIG. 7 is a schematic and partial representation in perspective of the withdrawal of the filter cartridge from the mandrel after its manufacture according to the method illustrated in FIG. 6.

FIG. 8 is a schematic and partial representation in perspective of the possibility of adding a ring in the method for manufacturing the filter cartridge illustrated in FIG. 6.

FIG. 9 a schematic representation in longitudinal section of a filter assembly according to a second embodiment of the disclosure, illustrated in operation.

FIG. 10 is an isolated, schematic and perspective representation of the second structural element of the internal structure of the filter assembly of FIG. 9.

FIG. 11 is an isolated, schematic and perspective representation of the first structural element of the internal structure of the filter assembly of FIG. 9.

FIG. 12 is a schematic, perspective and isolated representation of the filter cartridge of the filter assembly of FIG. 9.

FIG. 13 is an isolated, perspective and schematic representation of an alternative embodiment of the filter cartridge of FIG. 12.

FIG. 14 is a schematic representation in longitudinal section and in operation of a filter assembly according to a third embodiment of the disclosure.

FIG. 15 is a schematic representation, in an exploded view and in section, of the filter assembly of FIG. 14.

FIG. 16 is a schematic representation in longitudinal section of an alternative embodiment of the filter assembly of FIG. 14.

FIG. 17 is an isolated, schematic and perspective representation of a filter cartridge comprising a plurality of cavities that can be used in a filter assembly similar to that of FIG. 14.

FIGS. 18 and 19 are schematic and partial representations of the working of a filter assembly according to a fourth embodiment of the disclosure.

### DETAILED DESCRIPTION

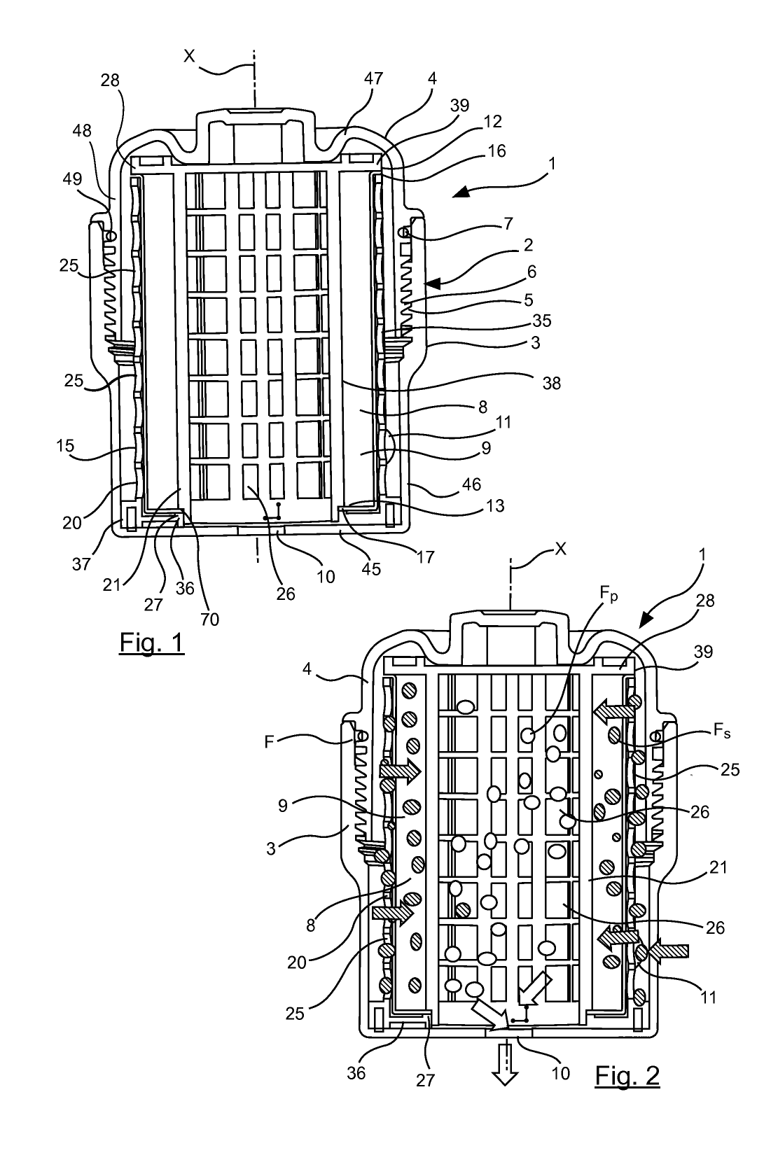

FIG. 1 shows a first embodiment of a filter assembly according to the disclosure. This is a filter assembly 1 to filter at least one fluid F flowing especially in a hydraulic motor or apparatus, or other fluids. The filter assembly 1 with a longitudinal axis X comprises a filter element 2, including a vessel 3 and a cover 4, cooperating with each other, for example by being screwed together.

The vessel 3 has a substantially flat bottom 45 and a cylindrical portion 46, in an upper portion of which there is formed an internal thread 5.

The cover 4 includes a cover part 47 and a cylindrical portion 48, in a lower part of which there is formed an external thread 6 laid out to cooperate with the internal thread 5 of the vessel 3.

A ring-shaped gasket 7 is also planned and housed in a circular groove 49 formed above the external thread 6 in the cover 4, as illustrated.

An aperture 10 formed in the bottom 45 of the vessel 3 enables the removal of filtered fluid Fp out of the filter assembly.

An aperture 11, partially visible in FIG. 1, enables the arrival of dirty fluid Fs to be filtered inside the filter assembly 1.

The filter assembly 1 includes a filter cartridge 8 positioned inside the filter element 2, this filter cartridge 8 being removable and constituted, in this example, exclusively by a filtering medium 9.

The filter assembly 1 comprises an internal structure 15 situated inside the filter element 2, fixedly joined to at least one part of the filter element 2, and configured to support the filter cartridge 8 in the filter element 2.

In the example shown, the filter cartridge 8 includes at least one filtering edge 17, in this example, two filtering edges 16 and 17 made at least partially out of filtering medium 9 and configured to form, with a part of the internal structure 15 with which the filtering edge or edges 16, 17 is or are in contact with one or more supporting areas 12, 13 of the filter cartridge 8.

In this example, the filter cartridge 8 includes a first filtering edge or upper filtering edge 16 forming substantially a rim extending on the rim of an upper end of the filter cartridge 8. The filter cartridge 8 includes, in this example, a second filtering edge, or lower filtering edge 17 extending internally to a lower end of the cartridge 8 throughout the internal periphery of this cartridge.

In this illustrated example, the filter cartridge 8 has a general cylindrical shape extending along the longitudinal axis X between an upper end 60 and a lower end 61. The filtering edges 16 and 17 extend perpendicularly to the longitudinal axis X, one (the upper filtering edge 16) towards the exterior of the cylinder, and the other (the lower filtering edge 17) towards the interior of the cylinder, as can be seen.

The supporting area 12, like the supporting area 13, is in this example laid out to prevent the passage of fluid F, except through the corresponding filtering edge 16 or 17.

Thus, the fluid F that might pass through one or through each of these filtering edges 16 or 17 would in any case be filtered, and this would in no way hamper the working of the filter assembly 1, and would, on the contrary, improve its operation.

It must be noted that the internal structure 15 fulfills a role, especially in this example, of a support for the filter cartridge 8, for example in order to prevent any longitudinal or crosswise movement of the cartridge during use.

In the example illustrated, the internal structure 15 includes a first structural element 20 and a second structural element 21, the first and the second structural elements 20 and 21 cooperating with each other to support the filter cartridge 8, especially by pressing on at least the filtering edge 16. In this example, the first and second structural elements 20 and 21 also cooperate to press on the filtering edge 17 and thus further improve the holding of the filter cartridge 8, between its two ends.

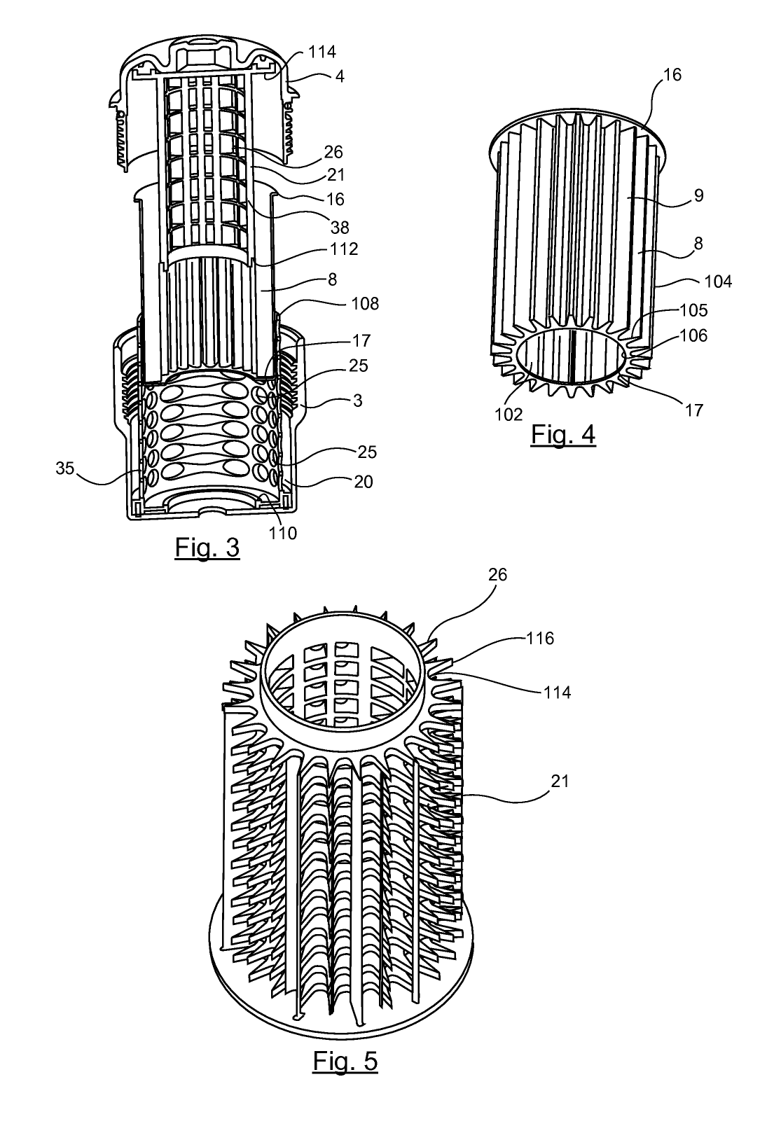

In this example, the first structural element 20 includes a plurality of apertures 25, which can be seen especially in FIG. 3, having substantially circular or oblong shapes and enabling the passage of dirty fluid Fs to be filtered. The second structural element 21 includes a plurality of apertures, which can be seen in FIGS. 1-3, substantially rectangular shapes in this example, enabling the passage of filtered fluid Fp.

In this example, and as indicated further above, the filter cartridge 8 has a generally cylindrical shape and a cross-section, visible in FIG. 4, in the shape of a multipointed star, giving a pleated appearance that increases the filtering surface area.

In this example too, the first structural element 20 has a cylindrical shape surrounding the filter cartridge 8, outside the supporting areas 12 and 13. The second structural element 21, also in this example, has a generally cylindrical shape surrounded by the filter cartridge 8, outside the supporting areas 12 and 13.

The filtering medium 9 forming the filter cartridge 8 can be cellulose, paper or cardboard, felt, a woven or non-woven, synthetic or non-synthetic material, an assembling of this, or any appropriate filtering medium.

The filtering medium 9 includes, in this example also, even if it is not visible to the naked eye, a plurality of layers of superimposed materials, in particular at least three, preferably at least ten and, in this example 25 superimposed layers. Each layer has a given thickness, ranging from 1 μm to 10 μm, for example, the total thickness could range from 0.5 mm to 2 mm, for example it could be equal to 1 mm.

In this first embodiment, the first structural element 20 is fixed in a tightly sealed way to the vessel 3 of the filter element 2 to separate the clean side from the dirty side, in order to prevent any migration of contamination from the filtered side. The second structural element 21 is fixed to the cover 4 of the filter element 2. The fixing of the first and second structural elements 20 and 21 can be done for example by clip-on means, screwing, soldering, gluing or the like.

In this example, the general shape of the first structural element 20 is a cylinder 35 having an external border 37 resting on the bottom 45 of the vessel 3 to hold it in the vessel 3 and provide the necessary space between the internal wall of the cylinder 46 of the vessel 3 and the wall of the cylinder of the first structural element 20 so as to enable the circulation of dirty fluid Fs that is to be filtered. The cylinder 35 has an inner border 36 with a supporting portion 27, in contact with the lower filtering edge 17.

The second structural element includes a cylinder shape 38 extending upwardly, in the form of a ring 28, towards the exterior of the cylinder 38. The cylinder 38 of the second structural element 21 has, in a lower portion, a ledge 70 shaped to cooperate with the support portion 27 in order to grip the lower filtering edge 17.

The rim 28 has an abutment portion 39 cooperating with the upper end of the cylinder 35 of the first structural element 20 to grip the filtering edge 16.

In this example, the filter cartridge 8 is thus completely gripped and surrounded by the internal structure 15 formed by the first structural element and the second structural element 20 and 21.

In one alternative embodiment, not shown, without departing from the framework of the disclosure, the first structural element is made as one piece with the vessel 3 and/or the second structural element 21 is made as one piece with the cover 4.

In another variant, it can be that the first structural element 20 and/or the second structural element 21 is not fixed to the vessel 3 and to the cover 4, respectively, of the filter element 2.

The filter assembly of FIG. 1 works as follows, with reference to FIG. 2.

The dirty fluid Fs to be filtered penetrates the filter assembly 1 through the aperture 11, as illustrated schematically by the arrow in FIG. 2. The dirty fluid Fs then passes through the apertures 25 of the first structural element 20 to pass through the filter cartridge 8. In passing through the filtering medium 9 forming the filter cartridge 8, the fluid is filtered and becomes clean at its exit from the filtering medium, inside the cylinder formed by the filter cartridge 8. The clean fluid Fp passes through the apertures 26 of the second structural element 21 and flows into the second structural element 21 to exit from the filter assembly 1 through the aperture 10 formed in the bottom of the vessel 3.

In the example illustrated in FIGS. 1-3, the second structural element 21 has an essentially cylindrical shape with a substantially smooth surface in addition to the area for fastening to the cover 4, at its upper part.

In one variant illustrated in FIG. 5, the second structural element 21, still provided with apertures 26, has a plurality of star-shaped spikes, ordered so as to substantially internally match the shape of the pleats of the filter cartridge 8 of this embodiment, in order to prevent the pleats from approaching each other under the pressure of the fluid, which usually creates a clogging of these pleats and a malfunctioning of the filter cartridge.

During the replacement of the filter cartridge 8, as shown in FIG. 3, the cover 4 is unscrewed from the filter element 2 outside the vessel 3 and then the used filter cartridge 8 is withdrawn and replaced with a new filter cartridge 8. The cover 4, fixedly joined to the second structural element 21 inside the vessel 3, is closed by screwing.

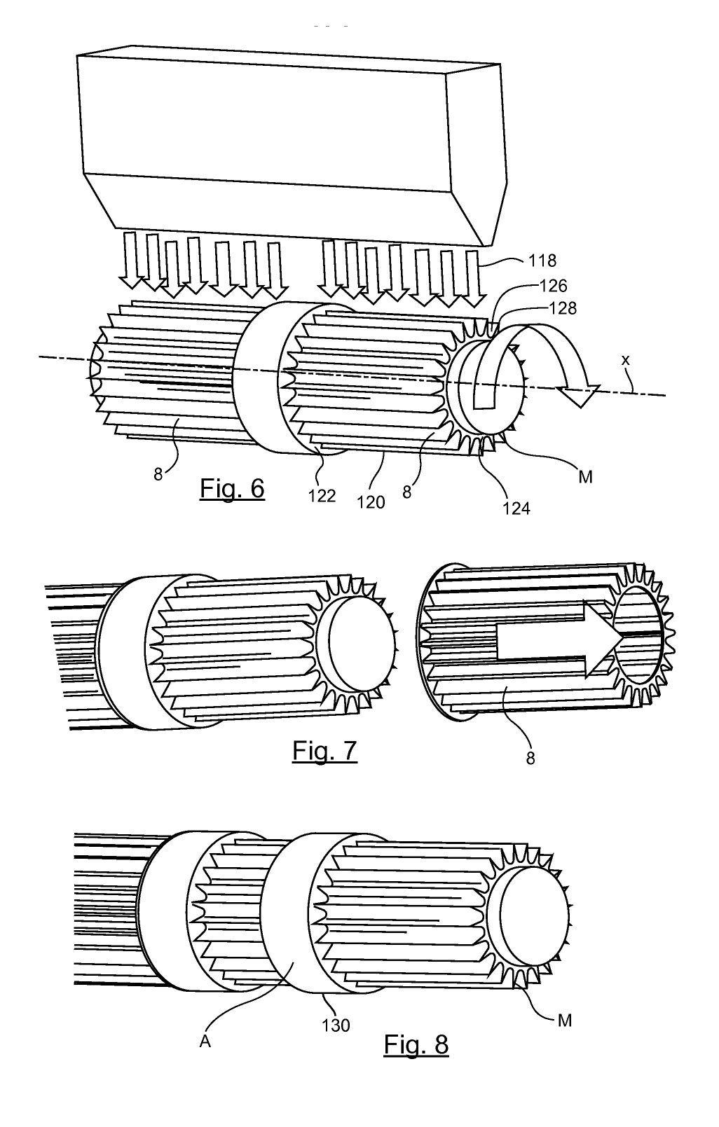

FIGS. 6-8 show an example of a method of a manufacture of the filter cartridge 8 of a filter assembly according to the disclosure. In the method of manufacture, fibers are thrown on to a mandrel M in one or more superimposed layers, in making the mandrel M rotate so as to uniformly distribute the fibers on its periphery.

In this example, the mandrel M comprises two mold portions having a general cylindrical shape with a star-shaped cross-section so as to form pleats. In the example illustrated, the mandrel M comprises two mold portions to simultaneously give two filter cartridges 8, but the arrangement could be otherwise without departing from the framework of the disclosure.

After a quantity of fibers sufficient to form the filter cartridge 8 has been deposited, the filter cartridge 8 is demolded, as illustrated in FIG. 7, along the longitudinal axis of the mandrel M.

As illustrated in FIG. 8, a ring A can be threaded on to the mandrel M to reduce the length of the filter cartridge 8 in order to match other filter assembly dimensions if necessary. This ring A is of course threaded on the mandrel M before the fibers are thrown on to the mandrel M. The filter cartridge 8 then formed will be shorter than a filter cartridge 8 made on the mandrel M without a ring A.

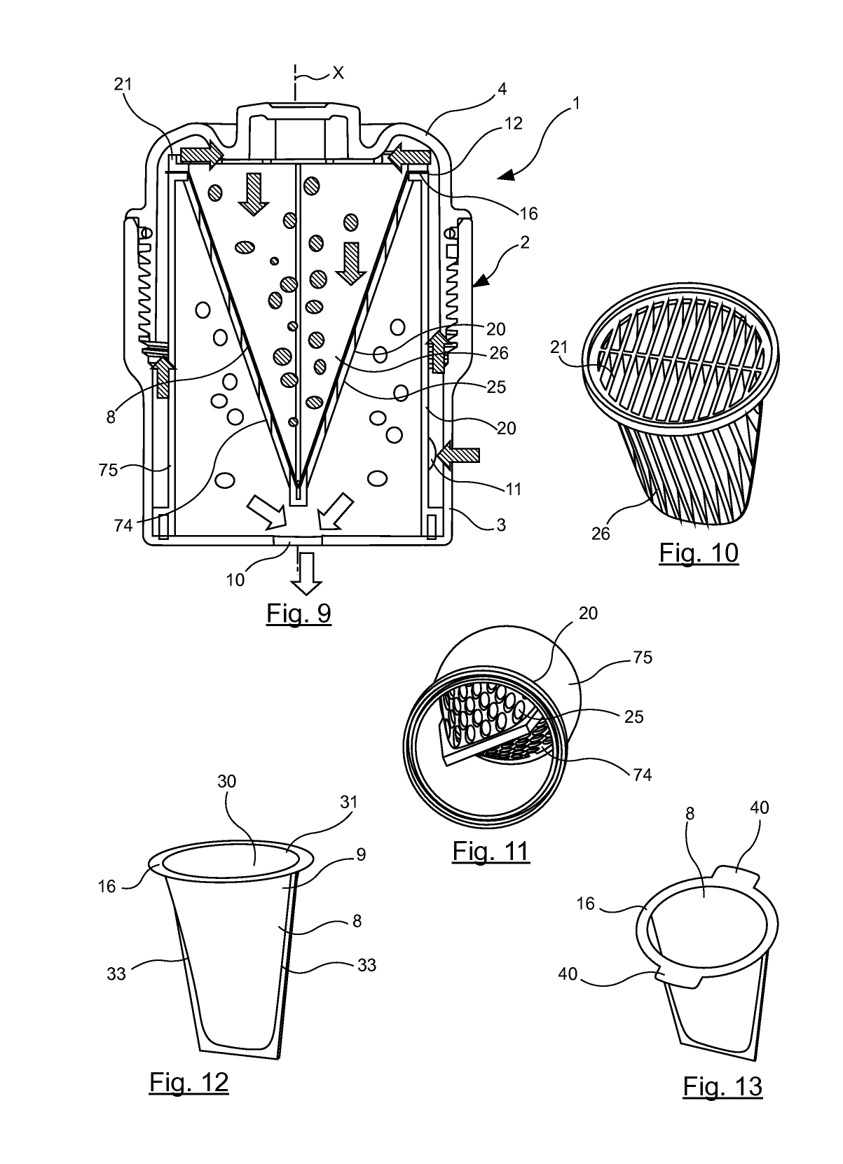

FIGS. 9-13 show a second embodiment of the disclosure.

In this second embodiment, the first structural element 20, fixed in a tightly sealed way to the vessel 3 of the filter element 2, includes a plurality of apertures 25 enabling the passage of the filtered fluid Fp, and the second structural element 21, fixed in a tightly sealed manner to the cover 4 of the filter element 2, includes a plurality of apertures 26 enabling the passage of dirty fluid Fs to be filtered.

In this embodiment, the filter cartridge 8, shown isolatedly in FIG. 12 and made entirely out of filtering medium 9, forms a cavity 30 open at a first end 31 and closed at a second opposite end 32. A solder 33 extends along two sides throughout the height of the filter cartridge 8 between the first end 31 and the second end 32 and along the second end 32.

A rim forming the filtering edge 16 extends on the periphery of the first end 31 of the filter cartridge 8 to be held between the first structural element 20 and the second structural element 21 in a supporting area 12.

The second structural element 21 shown in FIG. 10 has a plurality of apertures 26 each extending on two substantially vertical walls and forming slots which, as illustrated in FIG. 9, enable the flow of dirty fluid Fs and direct this fluid towards the filtering medium 9 forming the filter cartridge 8 through which the dirty fluid Fs flows in order to be filtered. Then the clean fluid Fp passes through the apertures 25 of the first structural element 20 and finally flows, as illustrated, through the aperture 10 formed in the bottom 45 of the vessel 3.

In this example, as can be seen, the second structural element 21 internally matches the shape of the filter cartridge 8. A part 74 of the first structural element 20, provided with apertures 25, externally matches the shape of the filter cartridge 8, as can be seen in FIGS. 9 and 11, while another portion 75, which is cylindrical, enables the fastening and fixed joining of the first structural element 20 to the vessel 3, in a tightly sealed way.

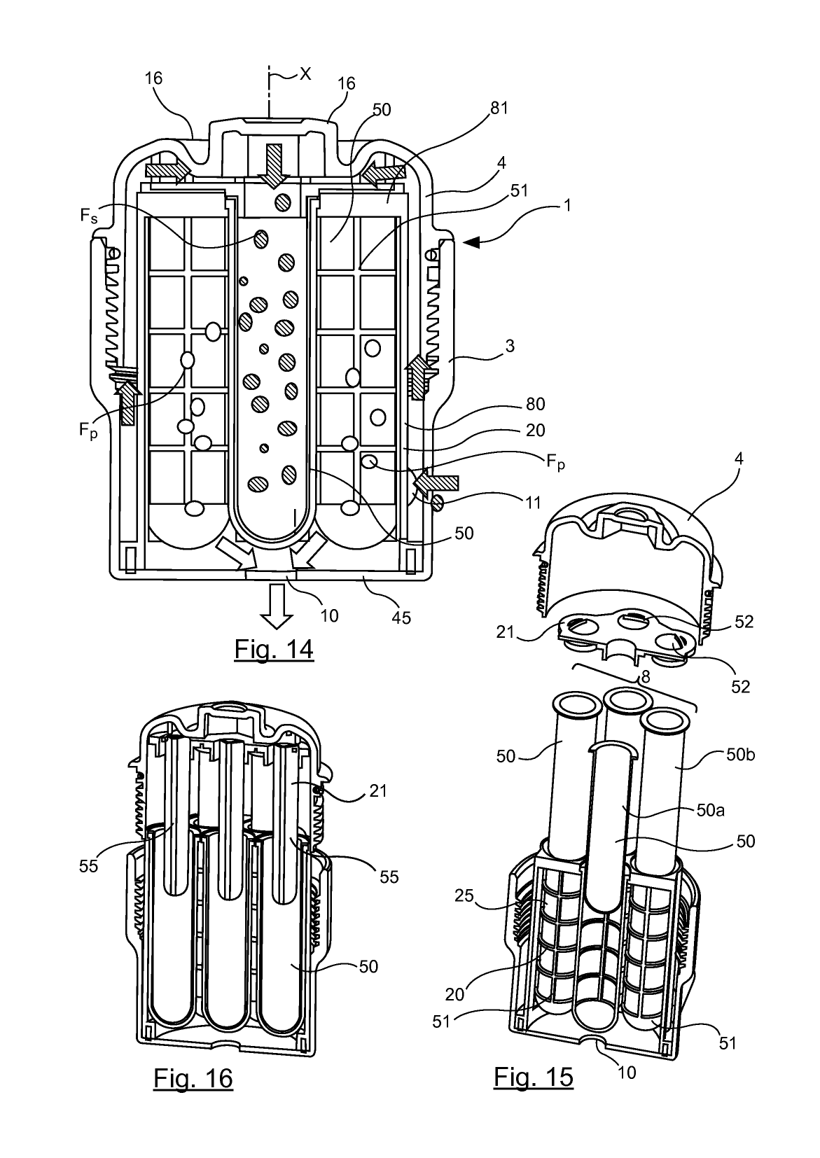

In one variant illustrated in FIG. 13, the filter cartridge 8 includes two handles 40 making it easier for the operator to replace the filter cartridge 8. These handles 40 extend from the filtering edge 16, as can be seen.

FIGS. 14 and 15 show a third embodiment of the filter assembly 1 according to the disclosure.

In this embodiment, the filter cartridge 8 includes a plurality of cavities 50, seven in the example shown, each having substantially a test-tube shape. The cavities are not connected to one another and each of them has an upper filtering edge 16.

The positioning of the different cavities 50 forming the filter cartridge 8 is symmetrical with a central cavity 50a and six cavities 50b surrounding the central cavity 50a.

In this example, the first structural element 20 forms a cylinder 80 surrounding the set of cavities 50 and has an upper edge 81 extending inside the cylinder 80 perpendicularly to the longitudinal axis X while at the same time leaving the apertures necessary to enable each of the cavities 50 of the filter cartridge 8 to be introduced.

The first structural element 20 has a plurality of cages 51 each having a plurality of apertures 25 to enable the passage of fluid and each cage surrounding cavities 50, as illustrated and seen in FIG. 15.

As for the second structural element 21, in this embodiment, it can form a cap drilled with apertures 52 corresponding to the apertures of the cavities 50 and making it possible, in cooperation with the first structural element 20, to hold all the filtering edges 16 of the cavities 50.

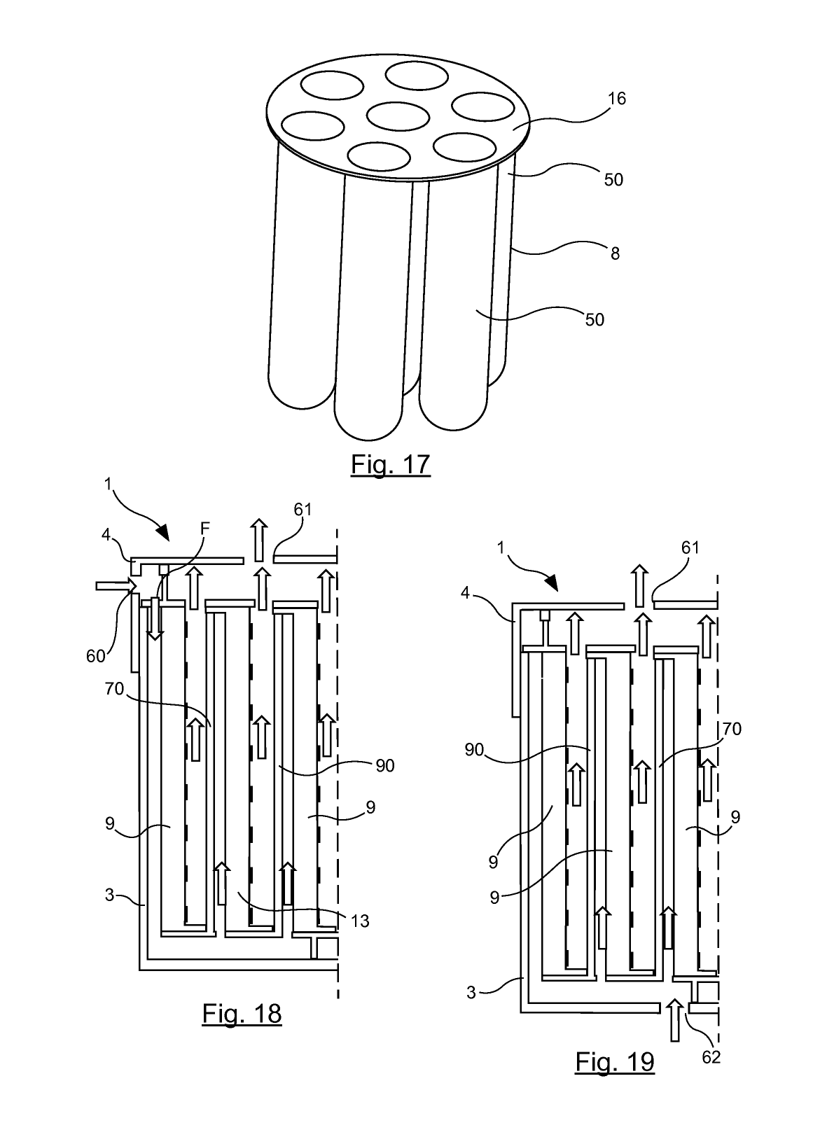

In the variant illustrated in FIG. 16, the second structural element 21 also includes protruding elements 55 which substantially match each of the cavities 50, so as to prevent the internal deformation of these cavities 50.

As illustrated in FIG. 14, this filter assembly 1 works as follows.

As in the other embodiments, the dirty fluid Fs penetrates through the aperture 11 and flows upwards, along the cylinder 80 of the first structural element 20. The dirty fluid Fs then penetrates, through the apertures 52 of the second structural element 21, into the cavities 50 and then, filtered through the filter cartridge 8 formed by the filtering medium 9 of each of the cavities 50, the clean fluid Fp flows out of these cavities 50 after having passed through the cages 51 of the first structural element 20 and flows through the aperture 10 formed at the bottom 45 of the vessel 3.

FIG. 17 shows the possibility of fixedly attaching together all the cavities 50 through a common filtering edge 16. In this case, the filter cartridge 8 is formed by a plurality of cavities, in this case seven cavities, and is formed as one piece, which facilitates its replacement.

The embodiment illustrated in FIGS. 18 and 19 schematically represents the possibility, for the clean fluid Fp to get removed no longer through the vessel 3 but through the cover 4. In the example illustrated in FIG. 18, the dirty fluid penetrates through an aperture 60 formed in the cover 4 while the clean fluid, after filtering, is removed through by the top of the cover 4 of the filter assembly 1. After it has entered the filter assembly 1, the fluid F follows the path indicated by the arrows. Several cavities are formed, each comprising, on one side, a filtering medium 9 and on the other side a tightly sealed wall 90 so that either the fluid penetrates the filtering medium 9 and is filtered and can then flow up to the outlet 61 of the filter assembly 1, or the fluid remains dirty and flows along tightly sealed walls 90 until it passes through a filtering wall formed by the filtering medium 9. All the filtering walls form the filter cartridge 8 of this filter assembly 1.

In the example illustrated in FIG. 19, the aperture 62 formed in the bottom of the vessel 3 enables the entry of the dirty fluid that is to be filtered. Just as in the embodiment of FIG. 18, either the dirty fluid passes through the filtering medium 9 or else it flows along tight-sealing walls 90 partly forming the internal structure within the filter element, without being able to come out, except through the filtering medium 9. Once filtered, the clean fluid flows in the cavities 70 along the walls 90 up to the aperture 61 formed at the top of the cover 4 of the filter assembly 1.

The present disclosure provides a filter assembly 1 to filter at least one fluid, the filter assembly comprising:
a filter element including a vessel and a cover,
a removable filter cartridge disposed inside the filter element, and constituted, in one embodiment, exclusively by a filtering medium,
an internal structure within the filter element, fixedly joined to at least a part of the filter element, configured to support the filter cartridge in the filter element.

Throughout the description, the expressions “including one” or “comprising one” must be understood as being synonymous with the expressions “including at least one” or “comprising at least one” respectively, unless the contrary is specified.

The disclosure provides a form-molded filter element cartridge 8 having a pass-through filter-media sidewall 9 through which fluid passes and is filtered, and having at least one filter-media flange 16 compressively engageable to form a seal between a first dirty unfiltered-fluid side of the filter-media sidewall 9 and a second clean filtered-fluid side of the filter-media sidewall. Filter element cartridge 8 is mounted in a canister housing or vessel 3 in endplateless gasketless relation. The filter element cartridge 8 is mounted in canister housing 3 closed by a lid or cover 4, and the filter-media flange 16 is engaged in compressed relation when canister housing is closed by lid 4, to provide the seal.

In one embodiment, the filter element cartridge 8 has a second filter-media flange 17 engaging canister housing 3 in compressed relation to form a second seal between the dirty unfiltered-fluid side of filter-media sidewall 9 and the second clean filtered-fluid side of the filter-media sidewall. Canister housing 3 extends axially along axis X between first and second distally opposite ends, e.g. upper and lower ends in the drawings, the first end being an open mouth closed by lid 4. Filter element cartridge 8 extends axially along axis X between distally opposite axial ends, e.g. upper and lower ends in the drawings, and has an axially extending hollow interior 102. Canister housing 3 has a circumferential sidewall 46 spaced radially outwardly of filter element cartridge 8. The filter element cartridge has an outer sidewall surface 104 facing circumferential sidewall 46 of canister housing 3, and has an inner sidewall surface 106 facing hollow interior 102. Filter-media flange 16 extends radially outwardly from outer sidewall surface 104. Filter-media flange 17 extends radially inwardly from outer sidewall surface 104. Filter-media flange 16 is at one of the axial ends, e.g. the upper end, of filter element cartridge 8. Filter-media flange 17 is at the other of the axial ends, e.g. the lower end, of filter element cartridge 8. Filter-media flange 16 is at the noted first upper end of the canister housing. Second filter-media flange 17 is at the noted second lower end of the canister housing.

In one embodiment, filter element cartridge extends frustoconically, FIGS. 9, 12, between the first and second filter-media flanges.

In one embodiment, filter element cartridge 8 is pleated, FIG. 4, and has inner and outer circumferences 106 and 104 radially spaced by pleats 105 extending radially therebetween. Second filter-media flange 17 extends radially between inner and outer circumferences 106 and 104.

In one embodiment, canister housing 3 has a first stanchion or structural element 20 extending axially along one of the inner and outer sidewall surfaces 106 and 104 of filter element cartridge 8, e.g. along outer sidewall surface 104. First stanchion 20 has a first shoulder 108 at first filter-media flange 16. Canister housing 3 has a second shoulder 110 at second filter-media flange 17. Lid 4 has a second stanchion or structural element 21 extending along the other of the inner and outer sidewall surfaces 106 and 104 of filter element cartridge 8, e.g. along inner sidewall surface 106. Second stanchion 21 has a third shoulder 112 at the second filter-media flange 17. Lid 4 has a fourth shoulder 114 at the first filter-media flange 16. First filter-media flange 16 is axially compressed between the first and fourth shoulders 108 and 114. Second filter-media flange 17 is axially compressed between the second and third shoulders 110 and 112. In one embodiment, one of the stanchions, e.g. stanchion 21, FIG. 5, has a star shape in radial cross-section, with the star shape having inner and outer star tips 114 and 116. Filter element cartridge 8 is pleated and has inner and outer pleat tips at 106 and 104 respectively supported at inner and outer star tips 114 and 116.

In another embodiment, filter-media sidewall 9, FIG. 12, extends from a filter-media flange at 31 and forms a bag having a closed end 32, and having an open mouth at filter-media flange 31 and circumscribed by such filter-media flange 31. In a further embodiment, the filter element cartridge 8 includes a plurality of such bags, e.g. at 50, FIG. 15, each having a respective filter media sidewall extending to a respective closed end, and each having an open mouth. In a further embodiment, filter-media flange 16, FIG. 17, circumscribes each of the open mouths individually, and also collectively circumscribes the group of open mouths.

In one embodiment, the noted seal at a minimum filters any fluid flow therethrough, such that one side of the seal is a dirty unfiltered-fluid side, and the other side of the seal is a clean filtered-fluid side.

In another embodiment, the noted seal blocks fluid flow therethrough.

In a further embodiment, the disclosure provides a fiber-projected form-molded filter element cartridge 8 having a pass-through fiber-filter-media sidewall 9 through which fluid passes and is filtered, and having at least fiber-filter-media flange, e.g. 16 and/or 17 and/or 31, compressively engageable to form a seal between a first dirty unfiltered-fluid side of the fiber-filter-media sidewall 9 and a second clean filtered-fluid side of the fiber-filter-media sidewall. The filter element cartridge 8 is mounted in a canister housing 3 closed by a lid 4, and the noted fiber-filter-media flange is engaged in compressed relation when the canister housing is closed by the lid, to provide the noted seal, which at a minimum filters any fluid flow therethrough such that one side of such seal is a dirty unfiltered-fluid side, and the other side of such seal is a clean filtered-fluid side, and at a maximum blocks fluid flow through such seal. In one embodiment, the filter element cartridge comprises meltblown fibers melt-spun on a form, such as mandrel M. Melt-spinning in a melt-spun process is known in the prior art, for example as shown in the following U.S. patents, incorporated herein by reference: U.S. Pat. Nos. 3,755,527; 6,860,917; 7,674,425; 8,231,752. In one embodiment, the form-molded filter element cartridge 8 constituted by the meltblown fibers melt-spun on form M provides the same number of pleats and a constant shape filter to filter.

The disclosure provides a method for making a filter element cartridge 8, the method including providing a form M, FIGS. 6-8, rotating the form M, projecting filter media fibers, at 118, onto form M while the form is rotating, providing the form M with a first section 120 forming a fiber-filter-media sidewall 9 for pass-through of fluid to be filtered, and a second section 122 forming a fiber-filter-media flange 16 compressively engageable to form the noted seal between a first dirty unfiltered-fluid side of the fiber-filter-media sidewall 9 and a second clean filtered-fluid side of the fiber-filter-media sidewall 9. The method includes projecting the filter media fibers by meltblowing the fibers in a melt-spun process, as above noted. The method includes rotating form M about an axis X, providing the first section 120 extending parallel to axis X, providing the second section 122 extending transversely of axis X, and projecting the filter media fibers at 118 radially toward axis X. In one embodiment, the method includes providing form M with a third section 124 axially spaced from second section 122 and extending transversely of axis X and forming a second fiber-filter-media flange 17 axially spaced from first fiber-filter-media flange 16 and compressively engageable to form a second seal between the first dirty unfiltered-fluid side of fiber-filter-media sidewall 9 and the second clean filtered-fluid side of the fiber-filter-media sidewall. In one embodiment, the method includes providing form M having a star shape in radial cross-section with inner and outer star tips 126 and 128 forming a pleated filter element cartridge 8 with complemental inner and outer pleat tips at 106 and 104, respectively, and after formation of the pleated filter element cartridge 8, stopping rotation of form M, and sliding, FIG. 7, the filter element cartridge 8 axially off of form M. In a further embodiment, prior to sliding filter element cartridge 8 off of form M, the filter element cartridge is cut along the circumference thereof at each of second and third sections 122 and 124. In a further embodiment, the method includes providing an adjustment sleeve 130, and axially sliding the adjustment sleeve along first section 120 to a desired location prior to projecting the filter media fibers at 118 onto form M, to provide a desired axial length of fiber-filter-media sidewall 9.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. Filter assembly to filter at least one fluid, the filter assembly comprising:
a filter element including a vessel and a cover,
a removable filter cartridge disposed inside the filter element, and constituted by a filtering medium,
an internal structure within the filter element, fixedly joined to at least a part of the filter element, configured to support the filter cartridge in the filter element.

2. Filter assembly according to claim 1, wherein the filter cartridge comprises at least one filtering edge, made at least partially, out of a filtering medium, and configured to form, with a part of the internal structure with which the filtering edge is in contact, a supporting area for the filter cartridge.

3. Filter assembly according to claim 2, wherein said supporting area is laid out to prevent the passage of fluid (F) except through the filtering edge.

4. Filter assembly according to claim 1, wherein the internal structure comprises a first structural element and a second structural element, the first and second structural elements cooperating with each other to support, especially by pressing on said at least one filtering edge, the filter cartridge.

5. Filter assembly according to claim 4, wherein the first structural element includes a plurality of apertures enabling the passage of dirty fluid (Fs) to be filtered and, respectively, enabling the passage of filtered fluid (Fp), and the second structural element comprises a plurality of apertures enabling the passage of filtered fluid (Fp) and, respectively, enabling the passage of dirty fluid (Fs) to be filtered.

6. Filter assembly according to claim 1, wherein the filter cartridge has a general cylindrical or truncated-cone shape and a cross-section with a shape chosen from among the following: a multipointed star shape, circular shape, substantially oval shape and almond shape.

7. Filter assembly according to claim 4, wherein the filter cartridge has an upper filtering edge, extending to an upper end of the filter cartridge, and a lower filtering edge, extending to a lower end of the filter cartridge, each of the upper and lower filtering edges being held closely, especially by pressing, between the first and second structural elements, in two supporting areas.

8. Filter assembly according to claim 4, wherein the first structural element at least partially has a general cylindrical or truncated-cone shape surrounding the filter cartridge or, respectively, surrounded by the filter cartridge, possibly outside the supporting area or areas and the second structural element at least partially has a generally cylindrical or truncated-cone shape, surrounded by the filter cartridge or, respectively, surrounding the filter cartridge, possibly outside the support area or areas.

9. Filter assembly according to claim 1, wherein the filtering medium forming the filter cartridge comprises a material chosen from the group constituted by cellulose, especially paper or cardboard, felt, a porous material, woven or non-woven, synthetic or non-synthetic material, a joining of these materials, or any other appropriate filtering medium.

10. Filter assembly according to claim 1, wherein the filtering medium includes a plurality of superimposed layers of materials, in particular at least three layers, preferably at least ten layers, even at least 25 layers, in particular 50 layers that are superimposed, or even more.

11. Filter assembly according to claim 4, wherein the first structural element is fixed in a tightly sealed way to the vessel of the filter element and the second structural element is fixed in a tightly sealed way to the cover of the filter element.

12. Filter assembly according to claim 4, wherein the second structural element has a shape arranged so as to appreciably match the shape of the filter cartridge, on an internal or external face of the filter cartridge.

13. Filter assembly according to claim 1, wherein the filter cartridge comprises at least one cavity open at a first end and closed at a second opposite end.

14. Filter assembly according to claim 13, wherein the filter cartridge comprises a plurality of cavities connected or not connected to one another, especially by means of a common filtering edge.

15. Filter assembly according to claim 13, wherein the internal structure comprises, for all the cavities or for each cavity, a first structural element and a second structural element.

16. A form-molded filter element cartridge having a pass-through filter-media sidewall through which fluid passes and is filtered, and having at least one filter-media flange compressively engageable to form a seal between a first dirty unfiltered-fluid side of said filter-media sidewall and a second clean filtered-fluid side of said filter-media sidewall.

17. The form-molded filter element cartridge according to claim 16 wherein said filter element cartridge is mounted in a canister housing in endplateless gasketless relation.

18. The form-molded filter element cartridge according to claim 16 wherein said filter element cartridge is mounted in a canister housing closed by a lid, and said filter-media flange is engaged in compressed relation when said canister housing is closed by said lid, to provide said seal.

19. The form-molded filter element cartridge according to claim 18 wherein said filter element cartridge has a second filter-media flange engaging said canister housing in compressed relation to form a second seal between said first dirty unfiltered-fluid side of said filter-media sidewall and said second clean filtered-fluid side of said filter-media sidewall.

20. The form-molded filter element cartridge according to claim 19 wherein said canister housing extends axially along an axis between first and second distally opposite ends, said first end being an open mouth closed by said lid, said filter element cartridge extends axially along said axis between distally opposite axial ends and has an axially extending hollow interior, said canister housing has a circumferential sidewall spaced radially outwardly of said filter element cartridge, said filter element cartridge has an outer sidewall surface facing said circumferential sidewall of said canister housing, and has an inner sidewall surface facing said hollow interior, said first mentioned filter-media flange extends radially outwardly from said outer sidewall surface, and said second filter-media flange extends radially inwardly from said outer sidewall surface.

21. The form-molded filter element cartridge according to claim 20 wherein said first filter-media flange is at one of said axial ends of said filter element cartridge, and said second filter-media flange is at the other of said axial ends of said filter element cartridge.

22. The form-molded filter element cartridge according to claim 21 wherein said first filter-media flange is at said first end of said canister housing, and said second filter-media flange is at said second end of said canister housing.

23. The form-molded filter element cartridge according to claim 22 wherein said filter element cartridge extends frustoconically between said first and second filter-media flanges.

24. The form-molded filter element cartridge according to claim 20 wherein said filter element cartridge is pleated and has inner and outer circumferences radially spaced by pleats extending radially therebetween, and said second filter-media flange extends radially between said inner and outer circumferences.

25. The form-molded filter element cartridge according to claim 20 wherein said canister housing has a first stanchion extending axially along one of said inner and outer sidewall surfaces of said filter element cartridge, said first stanchion has a first shoulder at said first filter-media flange, said canister housing has a second shoulder at said second filter-media flange, said lid has a second stanchion extending axially along the other of said inner and sidewall surfaces of said filter element cartridge, said second stanchion has a third shoulder at said second filter-media flange, said lid has a fourth shoulder at said first filter-media flange, said first filter-media flange is axially compressed between said first and fourth shoulders, said second filter-media flange is axially compressed between said second and third shoulders.

26. The form-molded filter element cartridge according to claim 25 wherein one of said stanchions has a star shape in radial cross-section, said star shape having inner and outer star tips, said filter element cartridge is pleated and has inner and outer pleat tips respectively supported at said inner and outer star tips.

27. The form-molded filter element cartridge according to claim 18 wherein said filter-media sidewall extends from said filter-media flange and forms a bag having a closed end, and having an open mouth at said filter-media flange and circumscribed by said filter-media flange.

28. The form-molded filter element cartridge according to claim 27 wherein said filter element cartridge comprises a plurality of said bags, each having a respective filter media sidewall extending to a respective closed end, and each having an open mouth.

29. The form-molded filter element cartridge according to claim 28 wherein said filter-media flange circumscribes each of said open mouths individually, and also collectively circumscribes the group of said open mouths.

30. The form-molded filter element cartridge according to claim 16 wherein said seal at a minimum filters fluid flow therethrough such that one side of said seal is a dirty unfiltered-fluid side, and the other side of said seal is a clean filtered-fluid side.

31. The form-molded filter element cartridge according to claim 16 wherein said seal blocks fluid flow therethrough.

32. A fiber-projected form-molded filter element cartridge having a pass-through fiber-filter-media sidewall through which fluid passes and is filtered, and having at least one fiber-filter-media flange compressively engageable to form a seal between a first dirty unfiltered-fluid side of said fiber-filter-media sidewall and a second clean filtered-fluid side of said fiber-filter-media sidewall.

33. The fiber-projected form-molded filter element cartridge according to claim 32 wherein said filter element cartridge is mounted in a canister housing closed by a lid, and said fiber-filter-media flange is engaged in compressed relation when said canister housing is closed by said lid, to provide said seal.

34. The fiber-projected form-molded filter element cartridge according to claim 32 wherein said filter element cartridge comprises meltblown fibers melt-spun on a form.

35. The fiber-projected form-molded filter element cartridge according to claim 34 wherein said filter element cartridge has a second fiber-filter-media flange engaging said canister housing in compressed sealing relation to form a second seal between said first dirty unfiltered-fluid side of said fiber-filter-media sidewall and said second clean filtered-fluid side of said fiber-filter-media sidewall, said canister housing extends axially along an axis between first and second distally opposite ends, said first end being an open mouth closed by said lid, said filter element cartridge extends axially along said axis between distally opposite axial ends and has an axially extending hollow interior, said canister housing has a circumferential sidewall spaced radially outwardly of said filter element cartridge, said filter element cartridge has an outer sidewall surface facing said circumferential sidewall of said canister housing, and has an inner sidewall surface facing said hollow interior, said first mentioned fiber-filter-media flange extends radially outwardly from said outer sidewall surface, said second fiber-filter-media flange extends radially inwardly from said outer sidewall surface, said filter element cartridge is pleated and has inner and outer circumferences radially spaced by pleats extending radially therebetween, said second fiber-filter-media flange extends radially between said inner and outer circumferences, said form-molded filter element cartridge comprising said meltblown fibers melt-spun on said form providing the same number of pleats and a constant shape filter to filter.

36. The fiber-projected form-molded filter element cartridge according to claim 32 wherein said seal at a minimum filters fluid flow therethrough such that one side of said seal is a dirty unfiltered-fluid side, and the other side of said seal is a clean filtered-fluid side.

37. The fiber-projected form-molded filter element cartridge according to claim 32 wherein said seal blocks fluid flow therethrough.

38. A method for making a filter element cartridge comprising providing a form, rotating said form, projecting filter media fibers onto to said form while said form is rotating, providing said form with a first section forming a fiber-filter-media sidewall for pass-through of fluid to be filtered, and a second section forming a fiber-filter-media flange compressively engageable to form a seal between a first dirty unfiltered-fluid side of said fiber-filter-media sidewall and a second clean filtered-fluid side of said fiber-filter-media sidewall.

39. The method according to claim 38 comprising projecting said filter media fibers by meltblowing said fibers in a melt-spun process.

40. The method according to claim 38 comprising rotating said form about an axis, providing said first section extending parallel to said axis, providing said second section extending transversely of said axis, projecting said filter media fibers radially toward said axis.

41. The method according to claim 40 comprising providing said form with a third section axially spaced from said second section and extending transversely of said axis and forming a second fiber-filter-media flange axially spaced from said first mentioned fiber-filter-media flange and compressively engageable to form a second seal between said first dirty unfiltered-fluid side of said fiber-filter-media sidewall and said second clean filtered-fluid side of said fiber-filter-media sidewall.

42. The method according to claim 41 comprising providing said form having a star shape in radial cross-section with inner and outer star tips forming a pleated said filter element cartridge with complemental inner and outer pleat tips, respectively, and after formation of said pleated filter element, stopping rotation of said form, and sliding said filter element cartridge axially off of said form.

43. The method according to claim 42 comprising, prior to sliding said filter element cartridge off of said form, cutting said filter element cartridge along the circumference thereof at each of said second and third sections.

44. The method according to claim 42 comprising providing an adjustment sleeve, and axially sliding said adjustment sleeve along said first section to a desired location prior to projecting said filter media fibers onto to said form, to provide a desired axial length of said fiber-filter-media sidewall.

45. The method according to claim 38 wherein said seal at a minimum filters fluid flow therethrough such that one side of said seal is a dirty unfiltered-fluid side, and the other side of said seal is a clean filtered-fluid side.

46. The method according to claim 38 wherein said seal blocks fluid flow therethrough.
